(19) United States
(12) Patent Application Publication
(10) Pub. No.: US 2024/0422796 A1
(43) Pub. Date: Dec. 19, 2024

(54) TRANSMISSION CONFIGURATION INDICATION STATE DETERMINATION METHOD AND APPARATUS, AND STORAGE MEDIUM

(71) Applicant: BEIJING XIAOMI MOBILE SOFTWARE CO., LTD., Beijing (CN)

(72) Inventor: Mingju LI, Beijing (CN)

(21) Appl. No.: 18/704,782

(22) PCT Filed: Oct. 29, 2021
(86) PCT No.: PCT/CN2021/127595

§ 371 Date: Apr. 25, 2024

(51) Int. Cl. H04W 72/232; H04L 5/00

(52) U.S. Cl. CPC H04W 72/232; H04L 5/0053; H04L 5/0091

(57) ABSTRACT

A transmission configuration indication (TCI) state determination method includes: receiving first configuration information, where the first configuration information is used for configuring at least two search space sets having a link relationship, and control resource set pool indexes of control resource sets corresponding to two search space sets in the at least two search space sets are different; and determining that a MAC CE to be received is a first MAC CE, where the first MAC CE is used for indicating at least one TCI state corresponding to each codepoint in at least one codepoint, the at least one codepoint is carried in a TCI field of DCI, and the DCI is transmitted by a PDCCH candidate resource in the at least two search space sets having a link relationship.

### BACKGROUND OF THE INVENTION

In New Radio (NR) technology, for example, when a communication frequency range is in a frequency range 2, due to the fast attenuation of a high-frequency channel, beam-based transmission and reception is needed to ensure coverage. When a network device (e.g., a base station) has multiple transmission reception points (TRPs), the multiple TRPs may be used to provide services to terminals, including the use of the multiple TRPs to send a physical downlink control channel (PDCCH) for the terminal.

### SUMMARY OF THE INVENTION

The disclosure provides a TCI state determination method and apparatus and a storage medium.

According to a first aspect of an example of the disclosure, a TCI state determination method is provided and performed by a terminal, including:
receiving first configuration information, where the first configuration information is used for configuring at least two search space (SS) sets having a link relationship, and control resource set pool indexes (CORESETPoolIndexes) of control resource sets corresponding to two search space sets in the at least two search space sets are different; and determining that a medium access control control element (MAC CE) to be received is a first MAC CE, where the first MAC CE is used for indicating at least one TCI state corresponding to each codepoint in at least one codepoint, the at least one codepoint is carried in a TCI field of DCI, and the DCI is transmitted by a physical downlink control channel candidate resource in the at least two search space sets having a link relationship.

According to a second aspect of an example of the disclosure, a TCI state determination method is provided and performed by a network device, including:
sending first configuration information, where the first configuration information is used for configuring at least two search space sets having a link relationship, and CORESETPoolIndexes of control resource sets corresponding to two search space sets in the at least two search space sets are different; and sending a first MAC CE, where the first MAC CE is used for indicating at least one TCI state corresponding to each codepoint in at least one codepoint, the at least one codepoint is carried in a TCI field of DCI, and the DCI is transmitted by a physical downlink control channel candidate resource in the at least two search space sets having a link relationship.

According to a third aspect of an example of the disclosure, a TCI state determination apparatus is provided, including:
a processor; and
a memory used for storing a processor executable instruction.

The processor is configured to: implement the TCI state determination method described in the first aspect or any implementation of the first aspect.

According to a fourth aspect of an example of the disclosure, a TCI state determination apparatus is provided, including:
a processor; and a memory used for storing a processor executable instruction.

The processor is configured to: implement the TCI state determination method described in the second aspect or any implementation of the second aspect.

According to a fifth aspect of an example of the disclosure, a computer storage medium is provided and stores an instruction, and the instruction, when executed by a processor, implements the TCI state determination method described in the first aspect or any implementation of the first aspect.

According to a sixth aspect of an example of the disclosure, a computer storage medium is provided and stores an instruction, and the instruction, when executed by a processor, implements the TCI state determination method described in the second aspect or any implementation of the second aspect.

It needs to be understood that the above general description and the detailed description below are merely examples and explanatory and do not limit the disclosure.

### BRIEF DESCRIPTION OF DRAWINGS

The accompanying drawings here are incorporated into the specification and constitute a part of the specification, show examples conforming to the disclosure, and together with the specification are used to explain the principle of the disclosure.

FIG. 1 is a schematic diagram of a wireless communication system illustrated by an example.

FIG. 2 is a schematic diagram of a MAC CE format under a single DCI (S-DCI) mechanism.

FIG. 3 is a schematic diagram of a MAC CE format under a multi-DCI (M-DCI) mechanism.

FIG. 4 is a flow chart of a TCI state determination method illustrated according to an example.

FIG. 5 is a flow chart of a method for determining a first MAC CE illustrated according to an example.

FIG. 6 is a flow chart of a TCI state determination method illustrated according to an example.

FIG. 7 is a flow chart of a TCI state determination method illustrated according to an example.

FIG. 8 is a block diagram of a TCI state determination apparatus illustrated according to an example.

FIG. 9 is a block diagram of a TCI state determination apparatus illustrated according to an example.

FIG. 10 is a block diagram of an apparatus for determining a TCI state illustrated according to an example.

FIG. 11 is a block diagram of an apparatus for determining a TCI state illustrated according to an example.

### DETAILED DESCRIPTION OF THE INVENTION

Examples will be described in detail here, instances of which are illustrated in the accompanying drawings. When the following description refers to the accompanying drawings, the same numbers in different drawings represent the same or similar elements unless otherwise indicated. The implementations described in the following examples do not represent all implementations consistent with the disclosure.

In the related art, the use of the multiple TRPs is supported to perform repetition transmission of the PDCCH (multi-TRP PDCCH repetition). For example, in multi-TRP PDCCH repetition, two control resource sets (CORESETs) are configured, and corresponding TCI states of the CORESETs are configured. One TCI state is configured for each CORESET correspondingly, and two search space sets (SS sets) are configured to correlate to the two CORESETs respectively. That is, two SS sets having a link relationship are configured to correlate to different CORESETs and correspond to different TCI states. The two SS sets having a link relationship may be understood as two PDCCH candidates with the same PDCCH candidate resource index in the two SS sets configured to send one piece of downlink control information (DCI). In a conventional approach, the TCI states of PDSCH repetition are indicated based on single DCI (S-DCI), that is, the CORESET pool indexes (CORESETPoolIndexes) of the CORESETs corresponding to the DCI are the same.

However, the CORESETPoolIndexes of the CORESETs corresponding to a plurality of SS sets having a link relationship used for PDCCH repetition transmission are different, it remains a problem how to configure the TCI states corresponding to codepoints in a TCI field in the DCI carried by the PDCCH candidates in the plurality of SS sets having a link relationship.

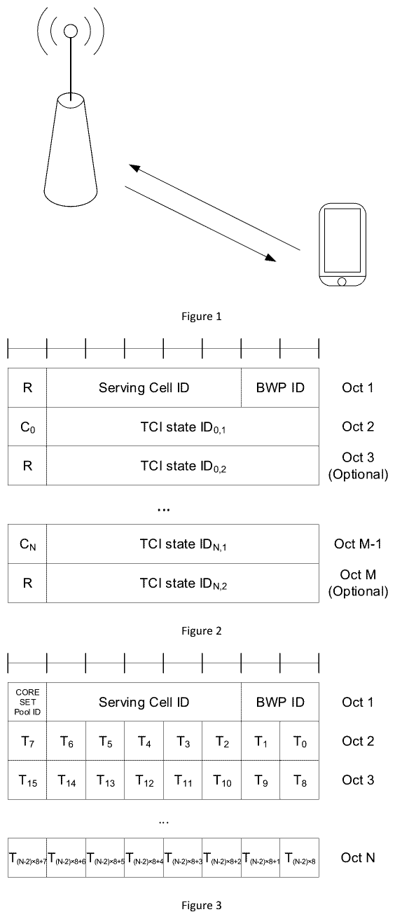

The disclosure relates to the technical field of communications, in particular to a transmission configuration indication (TCI) state determination method and apparatus, and a storage medium. The TCI state determination method provided by an example of the disclosure may be performed by a wireless communication system shown in FIG. 1. Referring to FIG. 1, the wireless communication system includes a terminal and a network device. The terminal is connected with the network device through radio resources and performs transmission and reception of data.

It may be understood that, the wireless communication system shown in FIG. 1 is merely for schematic illustration. The wireless communication system may further include other network devices, for example, core network devices, wireless relay devices, wireless backhaul devices, etc., which are not shown in FIG. 1. Examples of the disclosure do not limit the quantity of network devices and terminals included in the wireless communication system.

It may further be understood that, the wireless communication system in the example of the disclosure is a network providing a wireless communication function. The wireless communication system may adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), carrier sense multiple access with collision avoidance, etc. The network may be categorized as a 2G (second generation) network, a 3G network, a 4G network, or a future evolutionary network, for example, a 5G network, based on the capacity, rate, latency and other factors of different networks. The 5G network may also be referred to as a new radio (NR) network. For ease of description, the disclosure sometimes refers to the wireless communication system as a network.

Further, the network device involved in the disclosure may also be referred to as a wireless access network device. The wireless access network device may be: a base station, an evolved node B (eNB), a home base station, or an access point (AP), a wireless relay node, a wireless backhaul node, a transmission point (TP) or a transmission and reception point (TRP) in a wireless fidelity (WIFI) system, may also be a gNB in an NR system, or may be a component or part of a device that constitutes the base station. In the case of an Internet of Vehicles (V2X) communication system, the network device may also be a vehicle-mounted device. It needs to be understood that, the example of the disclosure does not limit a specific technology and specific device form adopted for the network device.

Further, the terminal involved in the disclosure may also be referred to as a terminal device, user equipment (UE), a mobile station (MS), a mobile terminal (MT), etc., and is a device providing speech and/or data connectivity for users. For example, the terminal may be a handheld device or a vehicle-mounted device having a wireless connection function. Currently, some examples of the terminal include: a mobile phone, a pocket personal computer (PPC), a palmtop, a personal digital assistant (PDA), a notebook computer, a tablet, a wearable device, or a vehicle-mounted device. In addition, in the case of an Internet of Vehicles (V2X) communication system, the terminal may also be a vehicle-mounted device. It needs to be understood that, the example of the disclosure does not limit a specific technology and specific device form adopted for the terminal.

In the disclosure, beam-based data transmission is performed between the network device and the terminal. During the beam-based data transmission, the network device (e.g., a base station) may send a PDCCH for the terminal using multiple TRPs (the multiple TRPs may also be referred to as Multi-TRPs). In the related art, when the network device (e.g., the base station) sends a PDCCH for the terminal using one TRP, a TCI state for receiving the PDCCH is configured for the terminal. For example, a configuration method is as follows: a CORESET such as CORESET #1 is configured for the terminal, and the TCI state correspondingly used when the terminal receives the PDCCH in a resource of the CORESET #1 is configured to be TCI #1; and a search space set (SS set) is configured for the terminal to correlate with the CORESET #1. When the terminal receives the PDCCH on the resource in the SS set, it uses a beam corresponding to TCI #1 for reception. Currently, each SS set can merely correlate with one CORESET, and each CORESET is configured with merely one TCI state (TCI state is also referred to as TCI state).

Beam-based data transmission is performed between the network device and the terminal in the disclosure. During the beam-based data transmission, when the network device (e.g., the base station) sends a PDCCH for the terminal by using multiple TRPs (the multiple TRPs may also be referred to as Multi-TRPs), the different TRPs send it by using different beams. The multiple TRPs may send the same PDCCH.

In order to realize that the multiple TRPs send the same PDCCH, a current method is as follows: two CORESETs are configured, one TCI state is configured for each CORESET correspondingly, and SS sets are configured to correlate to the two CORESETs respectively. That is, the two SS sets are configured to correlate to different CORESETs and correspond to different TCI states. There is also a correlation relationship between PDCCH candidates of the two SS sets having a link relationship. For example, a SS set #1 correlates to a SS set #2, and a PDCCH candidate #i in SS set #1 correlates to a PDCCH candidate #i in SS set #2, that is, two PDCCH candidates of the same index are used for sending the same DCI.

An application scenario of a plurality of TRPs sending the same PDCCH is multi-TRP PDCCH repetition. In multi-TRP PDCCH repetition, two CORESETs are configured, and corresponding TCI states of the CORESETs are configured. One TCI state is configured for each CORESET correspondingly, two SS sets having a link relationship are configured to correlate to different CORESETs and correspond to different TCI states. The two SS sets having a link relationship may be understood as two PDCCH candidates with the same PDCCH candidate index in the two SS sets configured to send one piece of DCI.

In a conventional approach, an S-DCI mechanism is supported to indicate the TCI states, that is, the CORESETPoolIndexes of the CORESETs corresponding to the DCI are the same. In the related art, a multi-DCI (M-DCI) mechanism is further supported to indicate the TCI states, that is the CORESETPoolIndexs of CORESETs corresponding to different pieces of DCI may be different.

The S-DCI mechanism and the M-DCI mechanism will be explained first below.

In the S-DCI mechanism, all CORESETs correspond to a CORESETPoolIndex 0 or no CORESETPoolIndex value is configured. Each codepoint in codepoints of a TCI field in DCI signaling may correspond to at most two TCI states, and a correspondence relationship is determined by a medium access control (MAC) control element (CE), and there is no need to distinguish between different TRPs. FIG. 2 is a schematic diagram of a MAC CE format under an S-DCI mechanism. As shown in FIG. 2, there are two footers i, and j below a TCI state ID. The footer i identifies a codepoint of TCI field 3 bit in the DCI to which the TCI state ID corresponds, e.g., i being 0 corresponds to a codepoint 000; i being 1 corresponds to a codepoint 001 . . . . The footer j identifies the TCI state ID as the jth of at least one TCI state ID corresponding to the ith codepoint. For example, j being 1 identifies the first and j being 2 identifies the second. For example, a footer 0, 1 identifies the first TCI state ID corresponding to codepoint 000. Referring to FIG. 2, each codepoint may correspond to at most two TCI states, i.e., to different TRPs, under the S-DCI mechanism.

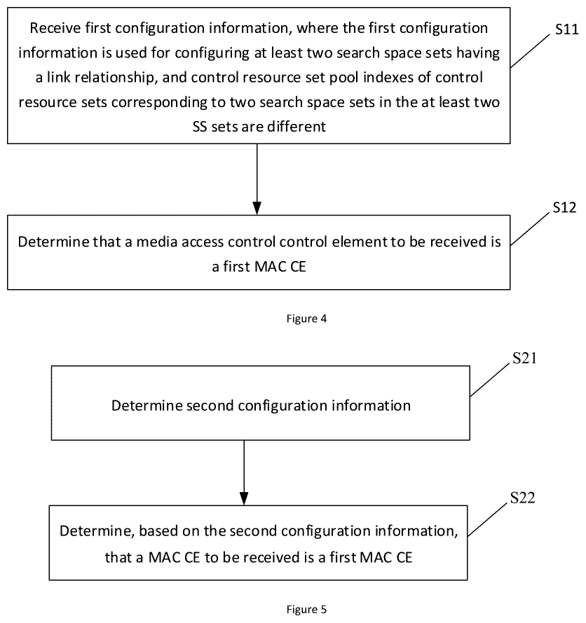

In the M-DCI mechanism, some CORESETs correspond to CORESETPoolIndex 0, and some CORESETs correspond to CORESETPoolIndex 1. Each codepoint in the codepoints of the TCI field in the DCI signaling may correspond to at most one TCI state, and the TCI states corresponding to the codepoints in the TCI field of CORESETs in different CORESETPoolIndex are determined by different MAC CEs. In the M-DCI mechanism, each MAC CE contain the CORESETPoolIndex and up to eight TCI states that need to be activated. FIG. 3 shows a schematic diagram of a MAC CE format under an M-DCI mechanism. As shown in FIG. 3, the MAC CE contains a CORESETPoolIndex. The MAC CE indicates the TCI state corresponding to the codepoint in the TCI field of DCI of at least one of CORESET included in the included CORESETPoolIndex. A plurality of Tis are given in FIG. 3, where i identifies a TCI state ID in RRC signaling, and if a bit position of Ti is 1, it identifies the activation of that TCI state ID. For example, for CORESETPoolIndex 0, the MAC CE activates TCI state #0, TCI state #4, TCI state #5, TCI state #12, TCI state #14, TCI state #26, TCI state #34, and TCI state #40, which correspond to codepoints 000,001,010,011,100,101,110,111, respectively, in the TCI fields of the DCI for CORESET #0 and CORESET #1 (which have a CORESETPoolIndex of 0), respectively. For another example, for CORESETPoolIndex 1, the MAC CE activates TCI state #70, TCI state #74, TCI state #75, TCI state #82, TCI state #84, TCI state #96, TCI state #104, TCI state #108, respectively, which correspond to the codepoints in the TCI field of the DCI for CORESET #2 and CORESET #3 (which have a CORESETPoolIndex of 1), respectively.

When the CORESETPoolIndexes of the CORESET corresponding to multiple SS sets having a linking relationship used for PDCCH repetition transmission are different, it remains a problem to be solved how to configure the TCI state corresponding to the codepoint of the TCI field in the DCI carried by the PDCCH candidate in that multiple SS set with linking relationship, either by the S-DCI mechanism or the M-DCI mechanism.

An example of the disclosure provides a TCI state determination method, so as to give indication of an activated TCI state corresponding to a codepoint included in a TCI field in DCI when CORESETPoolIndexs of CORESETs corresponding to two PDCCH candidates for PDCCH repetition.

FIG. 4 is a flow chart of a TCI state determination method illustrated according to an example. As shown in FIG. 4, the TCI state determination method is performed by a terminal, and includes the following steps.

In step S11, first configuration information is received. The first configuration information is used for configuring at least two SS sets having a link relationship, and CORESETPoolIndexes of CORESETs corresponding to two SS sets in the at least two SS sets are different.

In the example of the disclosure, the two SS sets having a link relationship may be understood as that two PDCCH candidates with the same PDCCH candidate index in the two SS sets are used for sending the same DCI, or may be understood as that the two SS sets are used for PDCCH repetition.

In step S12, a MAC CE to be received is determined as a first MAC CE.

The first MAC CE is used for indicating at least one TCI state corresponding to each codepoint in at least one codepoint, the at least one codepoint is carried in a TCI field of DCI, and the DCI is transmitted by a PDCCH candidate in the at least two SS sets having a link relationship.

In the example of the disclosure, when the CORESETPoolIndexs of the CORESET corresponding to a plurality of SS sets having a link relationship used for PDCCH repetition transmission are different, the first MAC CE indicates the TCI state corresponding to the codepoint included in the TCI field in the DCI.

The example of the disclosure will illustrate a process of determining the first MAC CE below.

In one implementation, configuration information used for indicating the first MAC CE may be configured by a network device, and is referred to as second configuration information below.

FIG. 5 is a flow chart of a method for determining a first MAC CE illustrated according to an example. As shown in FIG. 5, the method includes the following steps.

In step S21, the second configuration information is determined.

In step S22, the MAC CE to be received is determined as the first MAC CE based on the second configuration information.

In the example of the disclosure, the second configuration information is configured by the network device, and is used for indicating the first MAC CE. The terminal receives the second configuration information sent by the network device to determine the first MAC CE.

The second configuration information indicates at least one of: an assigned index value of the CORESETPoolIndex included in the MAC CE; or an assigned bit included in the MAC CE.

In one implementation, if the MAC CE received by the terminal satisfies at least one of A and B below indicated by the second configuration information, it determines the received MAC CE as the first MAC CE:
A: the CORESETPoolIndex included in the MAC CE has an assigned index value.
B: the MAC CE includes an assigned bit.

In an instance, the assigned index value may be a CORESETPoolIndex of a CORESET corresponding to a SS set not having a link relationship with any other SS set, and is referred to as a first index value below. For example, the first index value may be 0 or 1.

In another instance, the assigned index value may also be different from the CORESETPoolIndex of the CORESET corresponding to the SS set not having a link relationship with any other SS set, and is referred to as a second index value below. For example, the second index value may be a new CORESETPoolIndex assigned by the two SS sets having a link relationship. For example, the second index value may be 2. When a CORESET correlated to any SS set in the two SS sets having a link relationship further includes an independent SS set, the CORESETPoolIndex of the CORESET is still 0 or 1, and merely the CORESETPoolIndex of the two SS set having a link relationship is 2. An independent SS set is an SS set not having a link relationship with any other SS set.

In the example of the disclosure, when the CORESETPoolIndex in the MAC CE is the assigned index value, for example, 0 or 1 or the newly introduced 2, the MAC CE is the first MAC CE. Such a method may be understood as correspondence to a MAC CE under an M-DCI mode as shown in FIG. 3.

The assigned bit may be used for indicating whether the MAC CE is the first MAC CE.

In one implementation, the first configuration information configures a group of at least two SS sets having a link relationship, and the assigned bit is used for indicating whether the MAC CE to be received is the first MAC CE. In one instance, if there is merely one group of SS sets having a link relationship used for PDCCH repetition, the assigned bit used for indicating the first MAC CE merely needs to indicate a yes or no.

In another implementation, the first configuration information configures a plurality of groups of at least two SS sets having a link relationship, and the assigned bit is used for indicating a group marker of a group to which at least two SS sets having a link relationship belong. The group marker is configured by radio resource control (RRC) signaling, is determined based on an SS set with a smaller SS set ID in the corresponding SS set group, or is determined based on a CORESET with a smaller CORESET ID in a CORESET group corresponding to the SS set group. In an instance, if there is a plurality of groups of SS sets having a link relationship used for PDCCH repetition, the assigned bit used for indicating the first MAC CE needs to indicate a group market of a certain group of SS sets having a link relationship.

In the example of the disclosure, when the MAC CE includes the assigned bit used for indicating the first MAC CE, on the one hand, a way of determining the MAC CE to be the first MAC CE may be correspondence to a MAC CE under an S-DCI mode as shown in FIG. 2. On the other hand, the first MAC CE in the example of the disclosure may be a newly introduced MAC CE design. Newly introducing the MAC CE may refer to a case that a CORESETPoolIndex is introduced in the MAC CE shown in FIG. 2. When the CORESETPoolIndex is 0 or 1, each codepoint activates merely one TCI state. When the CORESETPoolIndex is 2, the case may be each codepoint activating two TCI state. The design of the newly introduced MAC CE may be understood as a MAC CE used for a SS set having a link relationship. In the example of the disclosure, the assigned bit may also be a CORESETPoolIndex corresponding to a CORESET. For example, a CORESETPoolIndex corresponding to a first group of SS sets is 2, a CORESETPoolIndex corresponding to a second group of SS sets is 3, and so on.

The above-mentioned second configuration information involved in the TCI state determination method provided by the example of the disclosure may, on the one hand, be determined based on the RRC signaling, that is, the terminal determines the first MAC CE based on second configuration information carried in the RRC signaling. For example, the network indicates, through the RRC signaling, for the terminal that when a CORESETPoolIndex in a MAC CE is the assigned index value, for example, 0 or 1 or the newly introduced value 2, the MAC CE is the first MAC CE. The network indicates, through the RRC signaling, for the terminal that the MAC CE includes the assigned bit, and the assigned bit is used for indicating whether the MAC CE is the first MAC CE.

The above-mentioned second configuration information involved in the TCI state determination method provided by the example of the disclosure may, on the other hand, be determined based on a default rule, that is, the terminal determines the first MAC CE based on protocol-defaulted second configuration information. For example, when the CORESETPoolIndex in the MAC CE is 0 or 1 or the newly introduced value 2, the MAC CE is the first MAC CE. Or, when the MAC CE includes the assigned bit and the assigned bit indicates yes, the MAC CE is the first MAC CE; or when the MAC CE includes the assigned bit and the assigned bit indicates the group marker of the SS set group, the MAC CE is the first MAC CE.

In the TCI state determination method provided by the example of the disclosure, the terminal may determine, based on the default rule, that the MAC CE to be received is the first MAC CE.

The default rule may include indicating any one of:
A1: the CORESETPoolIndex in the MAC CE is a CORESETPoolIndex value of a CORESET corresponding to an SS set with a smallest SS set market in the at least two SS sets;
B1: the CORESETPoolIndex in the MAC CE is a CORESETPoolIndex value corresponding to a CORESET with a smaller CORESET marker in the CORESETs corresponding to the at least two SS sets; or
C1: the CORESETPoolIndex value in the MAC CE is at least one index value between the first index value and the second index value. The first index value is 0 or 1, and the second index value is the newly introduced CORESETPoolIndex value 2.

In the example of the disclosure, the terminal may determine the first MAC CE based on the second configuration information, and/or the default rule.

Further, in the example of the disclosure, the terminal may subsequently receive the first MAC CE so as to determine, based on the received first MAC CE, an activated TCI state corresponding to a codepoint included in a TCI field in DCI, where the first MAC CE is used for indicating at most one TCI state corresponding to each codepoint in the at least one codepoint, or is used for indicating at most two TCI states corresponding to each codepoint in the at least one codepoint.

Further, the terminal may receive the DCI, and determine a codepoint included in the TCI field in the DCI. The codepoint is referred to as a first codepoint below. Based on a correspondence relationship between the TCI state indicated by the first MAC CE and the codepoint, the terminal may determine a TCI state corresponding to the first codepoint, and thus obtain the activated TCI state corresponding to the codepoint included in the TCI field in the DCI.

FIG. 6 is a flow chart of a TCI state determination method illustrated according to an example. As shown in FIG. 6, the TCI state determination method is eperformed by the terminal, and includes the following steps.

In step S31, the first MAC CE is received. The first MAC CE is used for indicating at most one TCI state corresponding to each codepoint in the at least one codepoint, or is used for indicating at most two TCI states corresponding to each codepoint in the at least one codepoint.

In step S32, the DCI is received, and the first codepoint included in the TCI field in the DCI is determined.

In step S33, the TCI state corresponding to the first codepoint is determined based on the correspondence relationship between the TCI state indicated by the first MAC CE and the codepoint.

For example, the first MAC CE is used for indicating at most one TCI state corresponding to each codepoint in the at least one codepoint, and the activated TCI state corresponding to the codepoint included in the TCI field in the DCI may be determined based on the M-DCI mechanism as shown in FIG. 3. For another example, the first MAC CE is used for indicating at most two TCI states corresponding to each codepoint in the at least one codepoint, and the activated TCI state corresponding to the codepoint included in the TCI field in the DCI may be determined based on the S-DCI mechanism as shown in FIG. 2.

In one implementation, the first MAC CE is used for indicating at least two TCI states corresponding to the at least one codepoint, and each TCI state in the at least two TCI states is used for uplink transmission and/or downlink transmission. That is, the at least two TCI states are both used for downlink, or the at least two TCI states are both used for uplink, or some of the at least two TCI states are used for uplink and some for downlink, or the at least two TCI states are both simultaneously used for uplink and downlink.

It may be understood that, in the example of the disclosure, downlink includes a downlink channel and/or a downlink signal. The downlink channel includes at least one of: a UE dedicated PDCCH, a non-UE dedicated PDCCH, a UE dedicated PDSCH, a non-UE dedicated PDSCH, or a physical broadcast channel (PBCH). The downlink signal includes at least one of: an SSB, a CSI reference signal (CSI-RS) (used for measurement of channel state information (CSI) and/or beam management), a tracking reference signal (TRS), a phase reference signal (PRS), or a demodulation reference signal (DMRS). The downlink signal may be periodic, semi-persistent, or non-periodic.

Uplink includes an uplink channel and/or an uplink signal. The uplink channel includes at least one of: a physical uplink control channel (PUCCH), a physical uplink shared channel (PUSCH), or a physical random access channel (PRACH). The uplink signal includes at least one of: a sounding reference signal (SRS), or a DMRS. The SRS is used for localization and/or for beam management and/or for codebook/non-codebook based channel measurement or antenna switching. The uplink signal may be periodic, semi-persistent or non-periodic.

Based on the same inventive concept, an example of the disclosure further provides a TCI state determination method. The TCI state determination method is performed by a network device.

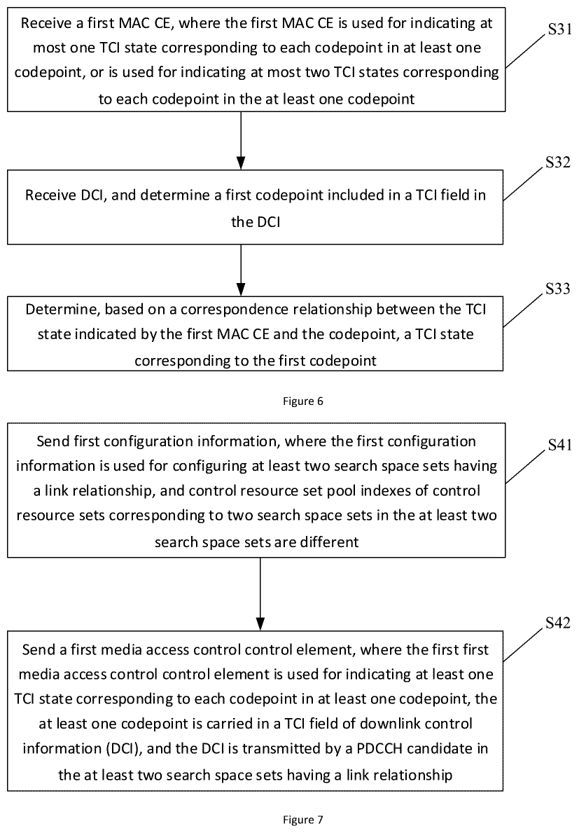

FIG. 7 is a flow chart of a TCI state determination method illustrated according to an example. As shown in FIG. 7, the TCI state determination method is performed by the network device, and includes the following steps.

In step S41, first configuration information is sent. The first configuration information is used for configuring at least two SS sets having a link relationship, and CORESETPoolIndexes of CORESETs corresponding to two SS sets in the at least two SS sets are different.

In step S42, a first MAC CE is sent. The first MAC CE is used for indicating at least one TCI state corresponding to each codepoint in at least one codepoint, the at least one codepoint is carried in a TCI field of DCI, and the DCI is transmitted by a PDCCH candidate in the at least two SS sets having a link relationship.

In one implementation, the network device may send second configuration information. The second configuration information is used for indicating the first MAC CE.

The second configuration information indicates at least one of: an assigned index value of the CORESETPoolIndex included in the MAC CE; or an assigned bit included in the MAC CE.

In one implementation, the assigned index value includes a first index value or a second index value. The first index value is a CORESETPoolIndex of a CORESET corresponding to a SS set not having a link relationship with any other SS set. For example, the first index value may be 0 or 1. The second index value may be different from the CORESETPoolIndex of the CORESET corresponding to the SS set not having a link relationship with any other SS set. For example, the second index value may be 2.

When a CORESET correlated to any SS set in the two SS sets having a link relationship further includes an independent SS set, the CORESETPoolIndex of the CORESET is still 0 or 1, and merely the CORESETPoolIndex of the two SS set having a link relationship is 2. An independent SS set is an SS set not having a link relationship with any other SS set.

In one implementation, the assigned bit is used for indicating at least one of:
the first configuration information configuring a group of at least two SS sets having a link relationship, and the assigned bit being used for indicating whether a MAC CE to be received is the first MAC CE; or the first configuration information configuring a plurality of groups of at least two SS sets having a link relationship, and the assigned bit being used for indicating a group marker of a group to which at least two SS sets having a link relationship belong.

In the example of the disclosure, when the MAC CE includes the assigned bit used for indicating the first MAC CE, on the one hand, a way of determining the MAC CE to be the first MAC CE may be correspondence to a MAC CE under an S-DCI mode as shown in FIG. 2. On the other hand, the first MAC CE in the example of the disclosure may be a newly introduced MAC CE design. Newly introducing the MAC CE may refer to a case that a CORESETPoolIndex is introduced in the MAC CE shown in FIG. 2. When the CORESETPoolIndex is 0 or 1, each codepoint activates merely one TCI state. When the CORESETPoolIndex is 2, the case may be each codepoint activating two TCI state. The design of the newly introduced MAC CE may be understood as a MAC CE used for a SS set having a link relationship. In the example of the disclosure, the assigned bit may also be a CORESETPoolIndex corresponding to a CORESET. For example, a CORESETPoolIndex corresponding to a first group of SS sets is 2, a CORESETPoolIndex corresponding to a second group of SS sets is 3, and so on.

In one implementation, the network device may send the second configuration information based on RRC signaling.

In one implementation, the first MAC CE is used for indicating at most one TCI state corresponding to each codepoint in the at least one codepoint, or is used for indicating at most two TCI states corresponding to each codepoint in the at least one codepoint.

In one implementation, the first MAC CE is used for indicating at least two TCI states corresponding to the at least one codepoint, and each TCI state in the at least two TCI states is used for uplink transmission and/or downlink transmission. That is, the at least two TCI states are both used for downlink, or the at least two TCI states are both used for uplink, or some of the at least two TCI states are used for uplink and some for downlink, or the at least two TCI states are both simultaneously used for uplink and downlink.

Downlink includes a downlink channel and/or a downlink signal. Uplink includes an uplink channel and/or an uplink signal.

It may be understood that, the TCI state determination method performed by the network device in the example of the disclosure corresponds to the TCI state determination method eperformed by the terminal. For some descriptions which are not detailed enough, reference may be made to some implementation solutions involved in the terminal side, and repetition will not be made here.

It may further be understood that, the TCI state determination method provided by the example of the disclosure is applicable to a process of realizing TCI configuration through interaction between the terminal and the network device.

It needs to be noted that, those skilled in the art may understand that the various implementations/examples involved above-mentioned in the examples of the disclosure may be used in conjunction with the foregoing examples or may be used independently. Whether they are used alone or together with the foregoing examples, the realization principles are similar. Some of the examples of the disclosure are illustrated in examples used together. Of course, those skilled in the art may understand that such an illustrative description is not a limitation of the examples of the disclosure.

Based on the same inventive concept, an example of the disclosure further provides a TCI state determination apparatus.

It may be understood that the TCI state determination apparatus provided in the example of the disclosure, in order to realize the above-mentioned functions, includes a hardware structure and/or a software module corresponding to the execution of the respective functions. In combination with the units and algorithmic steps of the various instances disclosed in the examples of the disclosure, the example of the disclosure can be realized in the form of hardware or a combination of hardware and computer software. Whether a particular function is performed as hardware or computer software driving hardware depends on the particular application and design constraints of the technical solution. Those skilled in the art may use a different approach for each particular application to implement the described functionality, but such implementation should not be considered outside the scope of the technical solutions of the examples of the disclosure.

FIG. 8 is a block diagram of a TCI state determination apparatus illustrated according to an example. Referring to FIG. 8, the TCI state determination apparatus 100 is performed by a terminal, and includes a receiving unit 101 and a processing unit 102.

The receiving unit 101 is configured to receive first configuration information. The first configuration information is used for configuring at least two SS sets having a link relationship, and CORESETPoolIndexes of CORESETs corresponding to two SS sets in the at least two SS sets are different. The processing unit 102 is configured to determine that a MAC CE to be received is a first MAC CE. The first MAC CE is used for indicating at least one TCI state corresponding to each codepoint in at least one codepoint, the at least one codepoint is carried in a TCI field of DCI, and the DCI is transmitted by a PDCCH candidate in the at least two SS sets having a link relationship.

In one implementation, the processing unit 102 is configured to determine that the MAC CE to be received is the first MAC CE through the following manner: second configuration information is determined; and the MAC CE to be received is determined to be the first MAC CE based on the second configuration information.

In one implementation, the second configuration information indicates at least one of: the CORESETPoolIndex included in the MAC CE having an assigned index value; or the MAC CE including an assigned bit.

In one implementation, the assigned index value includes a first index value or a second index value;

the first index value is a CORESETPoolIndex of a CORESET corresponding to a SS set not having a link relationship with any other SS set; and the second index value is different from the CORESETPoolIndex of the CORESET corresponding to the SS set not having a link relationship with any other SS set.

In one implementation, the assigned bit is used for indicating at least one of:
the first configuration information configuring a group of at least two SS sets having a link relationship, and the assigned bit being used for indicating whether a received MAC CE is the first MAC CE; or
the first configuration information configuring a plurality of groups of at least two SS sets having a link relationship, and the assigned bit being used for indicating a group marker of a group to which at least two SS sets having a link relationship belong.

In one implementation, the processing unit 102 is configured to: determine the second configuration information based on radio resource control signaling, or determine the second configuration information based on a default rule.

In one implementation, the default rule satisfies at least one of:
the CORESETPoolIndex in the MAC CE being a CORESETPoolIndex value of a CORESET corresponding to a SS set with a smallest SS set marker in the at least two SS sets;
the CORESETPoolIndex in the MAC CE being a CORESETPoolIndex value corresponding to a control resource set with a smaller CORESET marker in CORESETs corresponding to the at least two SS sets; or
a CORESETPoolIndex value in the MAC CE being at least one index value of the first index value or the second index value.

In one implementation, the receiving unit 101 is further configured to receive the first MAC CE, where the first MAC CE is used for indicating at most one TCI state corresponding to each codepoint in the at least one codepoint, or is used for indicating at most two TCI states corresponding to each codepoint in the at least one codepoint.

In one implementation, the receiving unit 101 is further configured to receive the DCI, and determine a first codepoint included in the TCI field in the DCI; and determine, based on the first MAC CE, a TCI state corresponding to the first codepoint.

In one implementation, the first MAC CE is used for indicating at least two TCI states corresponding to the at least one codepoint; and each TCI state in the at least two TCI states is used for uplink transmission and/or downlink transmission.

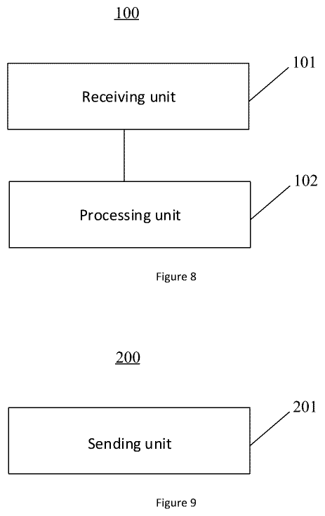

FIG. 9 is a block diagram of a TCI state determination apparatus illustrated according to an example. Referring to FIG. 9, the TCI state determination apparatus 200 is performed by a network device, and includes a sending unit 201.

The sending unit 201 is configured to send first configuration information. The first configuration information is used for configuring at least two SS sets having a link relationship, and CORESETPoolIndexes of CORESETs corresponding to two SS sets in the at least two SS sets are different; and the sending unit 201 is further configured to send a first MAC CE, where the first MAC CE is used for indicating at least one TCI state corresponding to each codepoint in at least one codepoint, the at least one codepoint is carried in a TCI field of DCI, and the DCI is transmitted by a PDCCH candidate in the at least two SS sets having a link relationship.

In one implementation, the sending unit 201 is configured to: send second configuration information, where the second configuration information is used for indicating the first MAC CE.

In one implementation, the second configuration information indicates at least one of:
an assigned index value of the CORESETPoolIndex included in the MAC CE; or
an assigned bit included in the MAC CE.

In one implementation, the assigned index value includes a first index value or a second index value;
the first index value is a CORESETPoolIndex of a CORESET corresponding to a SS set not having a link relationship with any other SS set; and
the second index value is different from the CORESETPoolIndex of the CORESET corresponding to the SS set not having a link relationship with any other SS set.

In one implementation, the assigned bit is used for indicating at least one of:
the first configuration information configuring a group of at least two SS sets having a link relationship, and the assigned bit being used for indicating whether a received MAC CE is the first MAC CE; or
the first configuration information configuring a plurality of groups of at least two SS sets having a link relationship, and the assigned bit being used for indicating a group marker of a group to which at least two SS sets having a link relationship belong.

In one implementation, the sending unit 201 sends the second configuration information based on radio resource control signaling.

In one implementation, the first MAC CE is used for indicating at most one TCI state corresponding to each codepoint in the at least one codepoint, or is used for indicating at most two TCI states corresponding to each codepoint in the at least one codepoint.

In one implementation, the first MAC CE is used for indicating at least two TCI states corresponding to the at least one codepoint; and each TCI state in the at least two TCI states is used for uplink transmission and/or downlink transmission.

Regarding the apparatus in the above example, specific operation performing modes of the modules have been described in detail in the example on the method, and detailed explanation or description will not be made here.

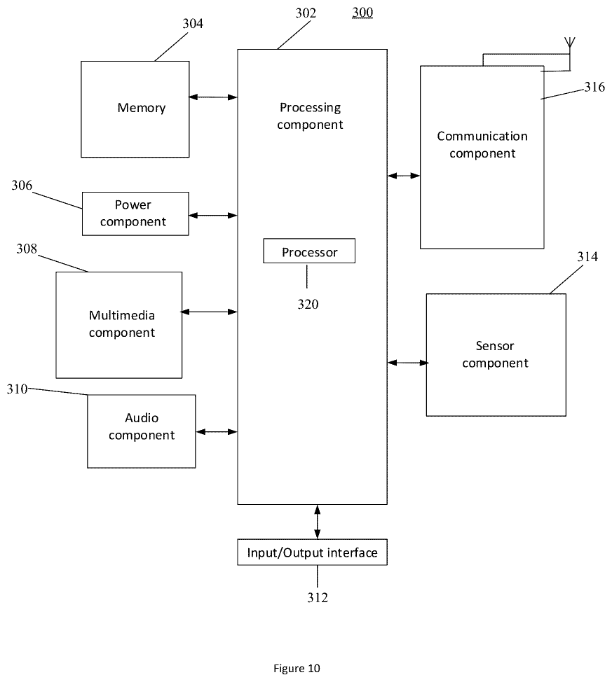

FIG. 10 is a block diagram of an apparatus 300 for TCI configuration illustrated according to an example. The apparatus 300 for TCI configuration may be provided as a terminal. For example, the terminal 300 may be a mobile phone, a computer, a digital broadcast terminal, a messaging device, a gaming console, a tablet, a medical device, fitness equipment, a personal digital assistant, and the like.

Referring to FIG. 10, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operations of the apparatus 300, such as operations associated with display, telephone calls, data communications, camera operations, and recording operations. The processing component 302 may include one or a plurality of processors 320 to execute instructions to complete all or part of the steps of the method described above. In addition, the processing component 302 may include one or a plurality of modules to facilitate the interaction between the processing component 302 and other components. For example, the processing component 302 may include a multimedia module to facilitate the interaction between the multimedia component 308 and the processing component 302.

The memory 304 is configured to store various types of data to support operations at the apparatus 300. Instances of such data include instructions for any applications or methods operated on the apparatus 300, contact data, phonebook data, messages, pictures, video, etc. The memory 304 may be implemented by any type of volatile or non-volatile memory devices or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or a compact disk.

The power component 306 provides power for various components of the apparatus 300. The power component 306 may include a power management system, one or a plurality of power sources, and any other components associated with generation, management and distribution of power for the apparatus 300.

The multimedia component 308 includes a screen providing an output interface between the apparatus 300 and a user. In some examples, the screen may include a liquid crystal display (LCD) and a touch panel (TP). If the screen includes the TP, the screen may be implemented as a touch screen to receive an input signal from the user. The touch panel includes one or a plurality of touch sensors to sense touch, swipe, and gestures on the touch panel. The touch sensors may not only sense a boundary of a touch or swipe action, but also detect duration and pressure related to the touch or swipe operation. In some examples, the multimedia component 308 includes a front camera and/or a rear camera. The front camera and/or the rear camera may receive external multimedia data when the apparatus 300 is in an operation mode, such as a photographing mode or a video mode. Each front camera and each rear camera may be fixed optical lens systems or may have focal lengths and optical zoom capabilities.

The audio component 310 is configured to output and/or input audio signals. For example, the audio component 310 includes a microphone (MIC) configured to receive an external audio signal when the apparatus 300 is in an operation mode, such as a call mode, a recording mode, and a voice recognition mode. The received audio signals may be further stored in the memory 304 or sent via the communication component 316. In some examples, the audio component 310 further includes a speaker configured to output audio signals.

The I/O interface 312 provides an interface between the processing component 302 and a peripheral interface module. The above-mentioned peripheral interface module may be a keyboard, a click wheel, or buttons. These buttons may include, but is not limited to: a home button, a volume button, a start button, and a lock button.

The sensor component 314 includes one or a plurality of sensors configured to provide status assessments of various aspects of the apparatus 300. For example, the sensor component 314 may detect an opened/closed state of the apparatus 300 and the relative positioning of the components such as a display and a keypad of the apparatus 300, and the sensor component 314 may also detect the position change of the apparatus 300 or a component of the apparatus 300, the presence or absence of contact between the user and the apparatus 300, the orientation or acceleration/deceleration of the apparatus 300, and the temperature change of the apparatus 300. The sensor component 314 may include a proximity sensor configured to detect the existence of nearby objects under the situation of no physical contact. The sensor component 314 may further include an optical sensor, such as a CMOS or CCD image sensor, for use in an imaging application. In some examples, the sensor component 314 may further include an accelerometer sensor, a gyroscope sensor, a magnetic sensor, a pressure sensor, or a temperature sensor.

The communication component 316 is configured to facilitate wired or wireless communication between the apparatus 300 and other apparatuses. The apparatus 300 may access a wireless network based on a communication standard, such as WiFi, 2G or 3G, or their combinations. In one example, the communication component 316 receives broadcast signals or broadcast related information from an external broadcast management system via a broadcast channel. In one example, the communication component 316 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In examples, the apparatus 300 may be implemented with one or a plurality of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, for performing the above method.

In examples, a non-transitory computer-readable storage medium including instructions is further provided, such as a memory 304 including instructions. The above instructions may be executed by a processor 320 in an apparatus 300, for executing the above method. For example, the non-transitory computer-readable storage medium may be a read only memory (ROM), a random access memory (RAM), a compact disc read only memory (CD-ROM), a magnetic tape, a floppy disk, an optical data storage apparatus, and the like.

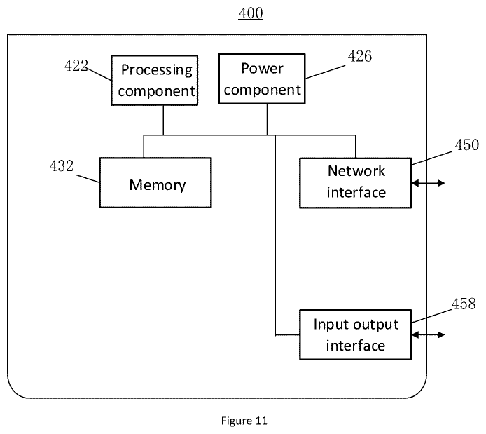

FIG. 11 is a block diagram of an apparatus 400 for TCI configuration illustrated according to an example. For example, the apparatus 400 may be provided as a network device. Referring to FIG. 11, the apparatus 400 includes a processing component 422, which further includes one or a plurality of processors, and a memory resource represented by a memory 432, configured to store instructions that may be executed by the processing component 422, such as an application program. The application program stored in the memory 432 may include one or more modules each corresponding to a set of instructions. In addition, the processing component 422 is configured to execute the instructions to execute the above method.

The apparatus 400 may further include a power supply component 426 configured to perform power management of the apparatus 400, a wired or wireless network interface 450 configured to connect the apparatus 400 to a network, and an input output (I/O) interface 458. The apparatus 400 may operate an operating system stored in the memory 432, such as Windows Server™, Mac OS X™, Unix™, Linux™, FreeBSD™ or the like.

In examples, the apparatus 400 may be implemented with one or a plurality of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, for executing the above method.

In examples, a non-transitory computer-readable storage medium including instructions is further provided, such as a memory 432 including instructions. The above-mentioned instructions may be executed by a processing component 422 in an apparatus 400, for executing the above method. For example, the non-transitory computer-readable storage medium may be a read only memory (ROM), a random access memory (RAM), a compact disc read only memory (CD-ROM), a magnetic tape, a floppy disk, an optical data storage apparatus, and the like.

It may further be understood that the “multiple” mentioned here refers to two or more, and it is also the case with other quantifiers. “And/or” describes a correlation relationship of a correlating object, and represents that there may be three kinds of relationships, for example, A and/or B, may represent: A exists alone, A and B exist at the same time, and B exists alone. A character “/” generally represents that the previous and next correlating objects are in a “or” relationship. Singular forms of “a”, “said” and “the” are also intended to include plural forms, unless the context clearly indicates otherwise.

It may further be understood that although the terms “first”, “second”, etc. are used to describe various information, the information should not be limited to these terms. These terms are only used to distinguish the same type of information from each other, without indication of any particular order or importance. Actually, the references “first”, “second”, etc. can be freely switched. For example, without departing from the scope of the disclosure, first information may also be referred to as second information, and similarly, second information may also be referred to as first information.

It may further be understood that examples of the disclosure, while describing operations in a particular order in the accompanying drawings, should not be construed as requiring that the operations be performed in the particular order shown or in a serial order, or that all of the operations shown be performed in order to obtain a desired result. Multitasking and parallel processing may be advantageous in particular environments.

Those skilled in the art will easily think of other examples of the disclosure after considering the specification and practicing the content disclosed here. The disclosure is intended to cover any variations, uses, or adaptive changes of the disclosure. These variations, uses, or adaptive changes follow the general principles of the disclosure and include common knowledge or conventional technical means in the technical field that are not disclosed in the disclosure.

It needs to be understood that the disclosure is not limited to the precise structure that has been described above and shown in the accompanying drawings, and various modifications and changes can be made without departing from its scope. The scope of the disclosure is only limited by the appended claims.

1. A transmission configuration indication (TCI) state determination method, performed by a terminal, and comprising:
receiving first configuration information, wherein the first configuration information is used for configuring at least two search space sets having a link relationship, and control resource set (CORESET) pool indexes of CORESET corresponding to two search space sets in the at least two search space sets are different; and
determining that a medium access control control element (MAC CE) to be received is a first MAC CE, wherein the first MAC CE is used for indicating at least one TCI state corresponding to each codepoint in at least one codepoint, the at least one codepoint is carried in a TCI field of downlink control information (DCI), and the DCI is transmitted by a physical downlink control channel candidate resource in the at least two search space sets having a link relationship.

2. The TCI state determination method according to claim 1, wherein determining that the MAC CE to be received is the first MAC CE comprises:
determining second configuration information; and
determining, based on the second configuration information, that the MAC CE to be received is the first MAC CE.

3. The TCI state determination method according to claim 2, wherein the second configuration information indicates at least one of:
a CORESET pool index comprised in the MAC CE having an assigned index value; or
the MAC CE comprising an assigned bit.

4. The TCI state determination method according to claim 3, wherein the assigned index value comprises a first index value or a second index value;
the first index value is a CORESET pool index of a CORESET corresponding to a search space set not having a link relationship with any other search space set; and
the second index value is different from the CORESET pool index of the CORESET corresponding to the search space set not having a link relationship with any other search space set.

5. The TCI state determination method according to claim 3, wherein the assigned bit is used for indicating at least one of:
the first configuration information configuring a group of at least two search space sets having a link relationship, and the assigned bit being used for indicating whether a received MAC CE is the first MAC CE; or
the first configuration information configuring a plurality of groups of at least two search space sets having a link relationship, and the assigned bit being used for indicating a group marker of a group to which at least two search space sets having a link relationship belong.

6. The TCI state determination method according to claim 2, wherein determining the second configuration information comprises:
determining the second configuration information based on a radio control signaling, or determining the second configuration information based on a default rule.

7. The TCI state determination method according to claim 6, wherein the default rule satisfies at least one of:
the CORESET pool index in the MAC CE being a CORESET pool index value of a CORESET corresponding to a search space set with a smallest search space set marker in the at least two search space sets;
the CORESET pool index in the MAC CE being a CORESET pool index value corresponding to a CORESET with a smaller CORESET marker in CORESETs corresponding to the at least two search space sets; or
a CORESET pool index value in the MAC CE being at least one index value of a first index value or a second index value.

8. The TCI state determination method according to claim 2, further comprising:
receiving the first MAC CE, wherein the first MAC CE is used for indicating at most one TCI state corresponding to each codepoint in the at least one codepoint, or is used for indicating at most two TCI states corresponding to each codepoint in the at least one codepoint.

9. The TCI state determination method according to claim 8, further comprising:
receiving the DCI;
determining a first codepoint comprised in the TCI field in the DCI; and
determining, based on the first MAC CE, a TCI state corresponding to the first codepoint.

10. The TCI state determination method according to claim 1, wherein the first MAC CE indicates at least two TCI states corresponding to the at least one codepoint; and
each TCI state in the at least two TCI states is used for at least one of uplink transmission or downlink transmission.

11. A transmission configuration indication (TCI) state determination method, performed by a network device, and comprising:
sending first configuration information, wherein the first configuration information is used for configuring at least two search space sets having a link relationship, and control resource set (CORESET) pool indexes of CORESETs corresponding to two search space sets in the at least two search space sets are different; and
sending a first medium access control control element (MAC CE), wherein the first MAC CE is used for indicating at least one TCI state corresponding to each codepoint in at least one codepoint, the at least one codepoint is carried in a TCI field of downlink control information (DCI), and the DCI is transmitted by a physical downlink control channel candidate resource in the at least two search space sets having a link relationship.

12. The TCI state determination method according to claim 11, wherein sending the first MAC CE comprises:
sending second configuration information, wherein the second configuration information is used for indicating the first MAC CE.

13. The TCI state determination method according to claim 12, wherein the second configuration information indicates at least one of:
an assigned index value of a CORESET pool index comprised in the MAC CE; or
an assigned bit comprised in the MAC CE.

14. The TCI state determination method according to claim 13, wherein the assigned index value comprises a first index value or a second index value;
the first index value is a CORESET pool index of a CORESET corresponding to a search space set not having a link relationship with any other search space set; and
the second index value is different from the CORESET pool index of the CORESET corresponding to the search space set not having a link relationship with any other search space set.

15. The TCI state determination method according to claim 13, wherein the assigned bit indicates at least one of:
the first configuration information configuring a group of at least two search space sets having a link relationship, and the assigned bit being used for indicating whether a received MAC CE is the first MAC CE; or
the first configuration information configuring a plurality of groups of at least two search space sets having a link relationship, and the assigned bit being used for indicating a group marker of a group to which at least two search space sets having a link relationship belong.

16. The TCI state determination method according to claim 12, wherein sending the second configuration information comprises:
sending the second configuration information based on a radio control signaling.

17. The TCI state determination method according to claim 12, wherein
the first MAC CE is used for indicating at most one TCI state corresponding to each codepoint in the at least one codepoint, or is used for indicating at most two TCI states corresponding to each codepoint in the at least one codepoint.

18. The TCI state determination method according to claim 12, wherein
the first MAC CE is used for indicating at least two TCI states corresponding to the at least one codepoint; and
each TCI state in the at least two TCI states is used for at least one of uplink transmission or downlink transmission.

19. (canceled)

20. (canceled)

21. A transmission configuration indication (TCI) state determination apparatus, comprising:
one or more processors; and
a memory used for storing a processor executable instruction; wherein
the one or more processors are collectively configured to, when executing the processor executable instruction:
receive first configuration information, wherein the first configuration information is used for configuring at least two search space sets having a link relationship, and control resource set (CORESET) pool indexes of CORESETs corresponding to two search space sets in the at least two search space sets are different; and
determine that a medium access control control element (MAC CE) to be received is a first MAC CE, wherein the first MAC CE is used for indicating at least one TCI state corresponding to each codepoint in at least one codepoint, the at least one codepoint is carried in a TCI field of downlink control information (DCI), and the DCI is transmitted by a physical downlink control channel candidate resource in the at least two search space sets having a link relationship.

22. A transmission configuration indication (TCI) state determination apparatus, comprising:
one or more processors; and
a memory used for storing a processor executable instruction; wherein
the one or more processors are collectively configured to: implement the TCI state determination method according to claim 11.

23. (canceled)

24. (canceled)
